(19) United States
(12) Patent Application Publication
(10) Pub. No.: US 2009/0007387 A1
(43) Pub. Date: Jan. 8, 2009

(54) Custom Grip for Writing Instruments and Other Hand Held Items

(76) Inventor: Aldo A. Laghi, (US)

Correspondence Address: CATHIE WELGE, 2895 42 AVENUE NORTH, ST. PETERSBURG, FL, 33714, US

(21) Appl. No.: 11/773,107

(22) Filed: Jul. 3, 2007

(51) Int. Cl. B25G 1/10

(52) U.S. Cl. 16/421; 16/430

(57) ABSTRACT

Custom Grip for writing instruments and other hand held tools and devices are made of thermoplastic materials which exhibit plasticity at temperatures in the range of 50-70 degrees Celsius. Therefore the users mold the grips to their hands by heating the grips and then holding them in firm grip.

### BACKGROUND INFORMATION

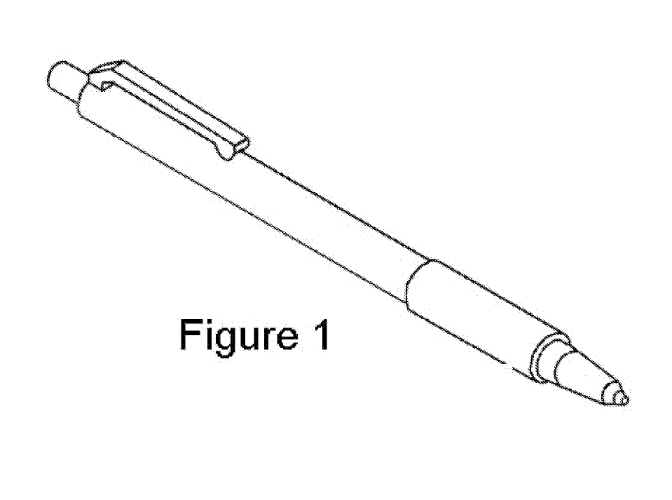

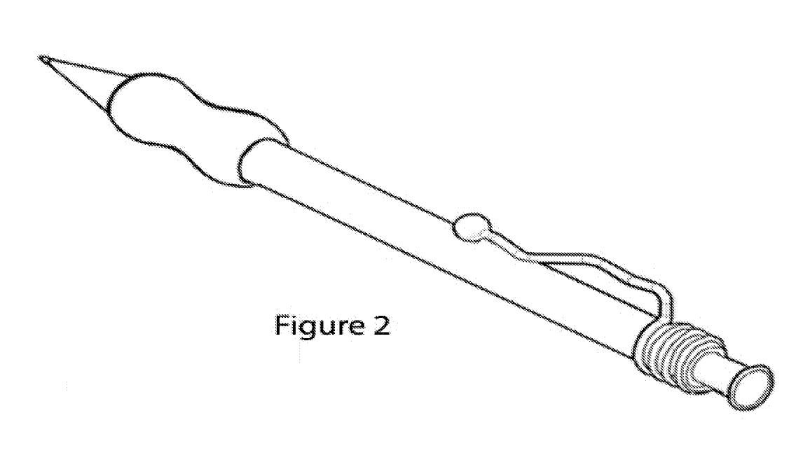

Pens and pencils have historically been of a tubular shape because of ease of manufacturing. In the early 2000's there have been pens with grips made of rubber or softer plastics, shaped in cylindrical shapes (FIG. 1) or bellow shapes (FIG. 2), this because it is understood by the people skilled in the art that a better grip would ease the fatigue of writing. Better grip can also be a larger diameter, or a triangular shape or polygonal shape. A better grip lessens writing fatigue by allowing good control of the writing instrument because the fingers of the writer can obtain adequate control of the pen with a lower level of strength for holding the pen.

### CURRENT INVENTION

The current invention consists of custom grips for pens and pencils and other hand held items. These grips are obtained by using thermoplastic polymers that exhibit plasticity at temperatures low enough that the grip can be molded by the fingers or the hands of the user without burning the skin and without causing discomfort.

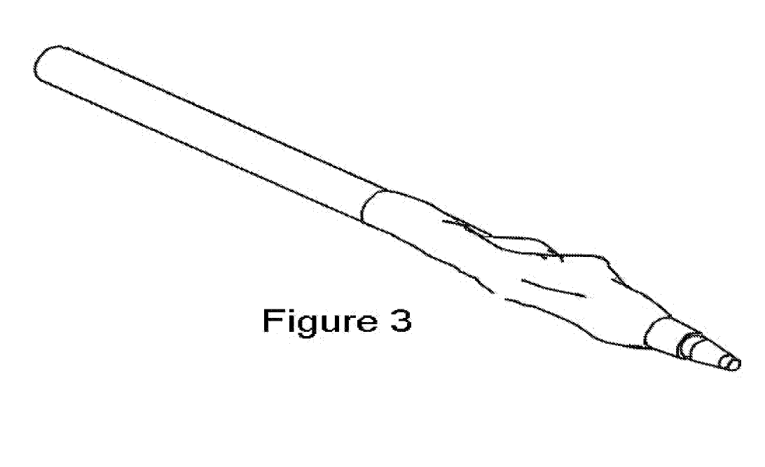

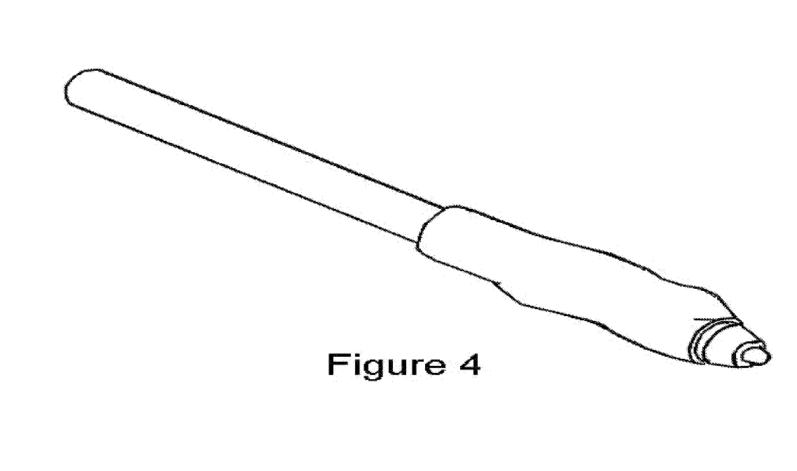

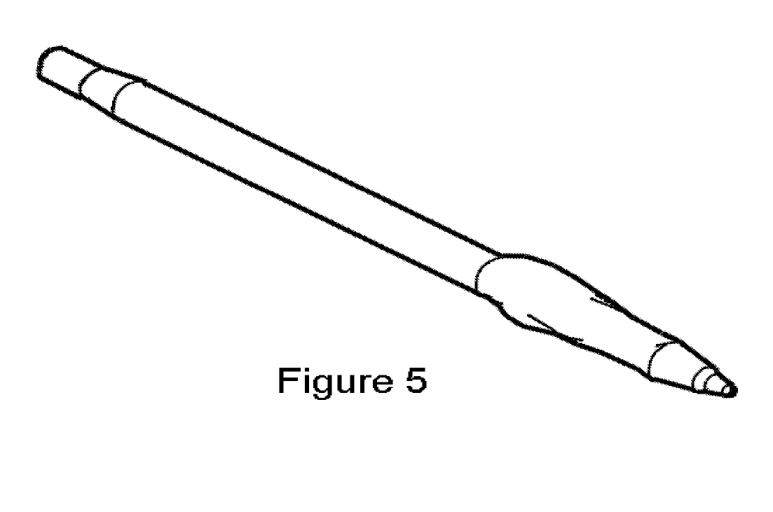

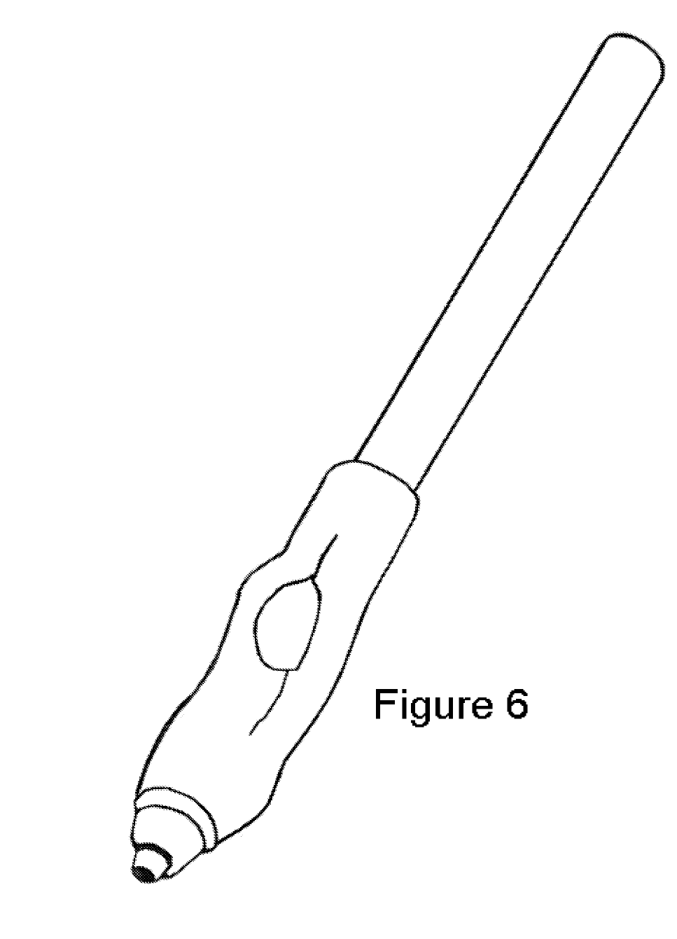

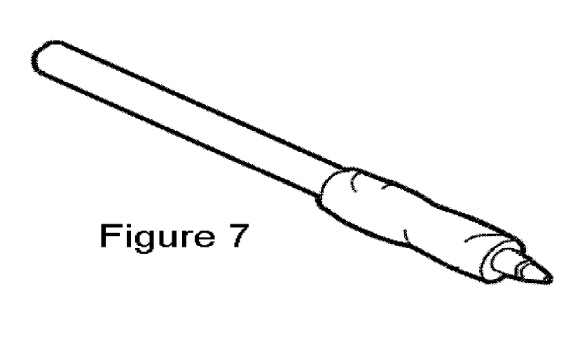

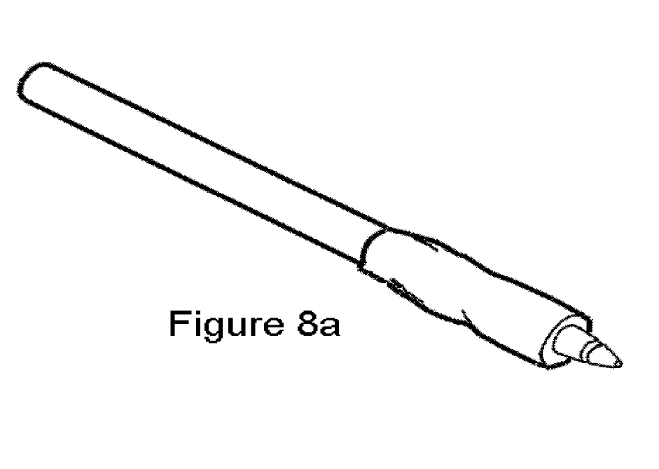

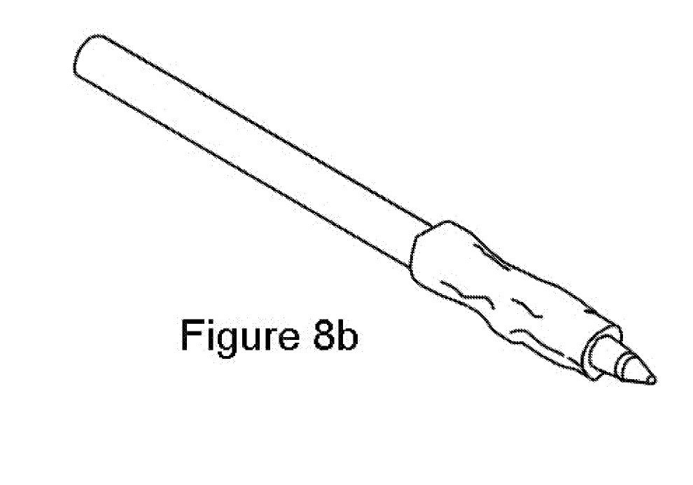

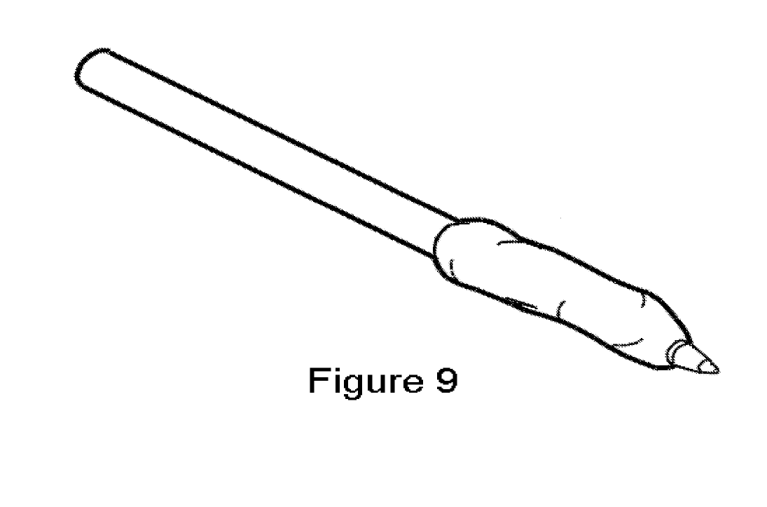

Typical polymers used are the following:
a. Caprolactones (CAPA) such as: (Solvay) (FIG. 3)—ATTACHMENT 1
b. Ethyl Vinyl Acetate (EVA)—such as Elvax 40, Elvax 150, Elvax 210 from DUPONT (FIG. 4)
c. Low temperature hot melts such as HS-230 Cool Pac Glue, HS-103 Multi Temp Glue Stick, Cool 1 OK 34-250 (FIG. 5)—ATTACHMENT 2 Easypac Hot Melt
d. Other suitable polymers exhibiting plasticity at low temperatures
e. Or combinations of some of the above plus a cover to the grip that can be made out of:
   1. Fabric—FIG. 6
   2. Rubber—FIG. 7
   3. Plastic Film—FIG. 8
   4. Plastic Tubing—FIG. 9
   5. Other Suitable Covering

### DETAILED DESCRIPTION

The writing instrument is covered at least in the lower half with a layer of thermoplastic material such as those described above, to provide the custom grip. An optional cover may be applied on the thermoplastic polymer. The pen is then sold to the retailer or to the user. In order to form a grip in the shape of the user's hand, the barrel of the pen or the entire pen is heated to the temperature corresponding to the plastic point of polymer used for the grip.

The heating can be effected in hot water approximately at 60° C. for DuPont polymers for about 4-5 minutes, for the Poly Caprolactones and the Elvax 40, or in a microwave for around 30 seconds for Eva's type of materials as these polymers are microwavable. If microwaving is preferred for polymers other than EVA, fillers such as iron filings may be added to the polymers in order to get a microwavable compound. Then the grip is grasped by the user and held in its normal writing position until the grip takes the shape of the owner's fingers.

DuPont Ethylene-Vinyl Acetate Copolymer Resins

| | Elvax 40 | Elvax 150 | Elvas 210 |
|---|---|---|---|
| Melt Index ° C. | 52 | 43 | 400 |
| Density at 23° C. | 965 | 957 | 951 |
| Tensile Strength MPa (psi) | 5.2-6.2 | 6.9-8.3 | 2.8 |
| Elongation at Break | 1000-1300 | 900-1100 | 800-1000 |
| Elastic (Tensile) Modulus | 3.0 (450) | 10.0 (1400) | 12 |
| MPa (psi) | | | |
| Hardness, Shore A-2 Durometer | 40 | 65 | 62 |
| Softening Point Ring & Ball ° C. | 104 | 110 | 82 |

Caprolactones (CAPA)

| | 6500 | 6430 | 6400 | 6800 | 6250 |
|---|---|---|---|---|---|
| Physical Form | Approx 3 mm | Approx 3 mm | Approx 3 mm | Approx 3 mm | Approx 3 mm |
| | pellets | pellets | pellets | pellets | pellets |
| Mean Molecular | 50,000 | 43,000 | 37,000 | 80,000 | 25,000 |
| Weight | | | | | |
| Melting Point | 58° C.-60° C. | 58° C.-60° C. | 58° C.-60° C. | 58° C.-60° C. | 58° C.-60° C. |
| Elongation at | 800% | 660% | 660% | 800% | 660% |
| Break | | | | | |
| Melt Flow | 7 g/10 min. | 13 g/10 min | 40 g/10 min | 3 g/10 min. | 9 g/10 min |
| Index | with a 2.16 kg | with 2.16 kg, | with 2.16 kg, 1′ | with a 2.16 kg | with 2.16 kg, |
| | standard die | 1′ PVC die @ | PVC die @ | standard die | 1′ PVC die @ |
| | at 160° C. | 160° C. | 160° C. | at 160° C. | 80° C. |

Low Temperature Hot Melts

| | HS-2300 CoolPac | HS-103 Multi Temp |
|---|---|---|
| Viscosity | 5,000 cps @ 250° F. | 8,465 cps @ 350° F. |
| Hardness | 86 A | 71 A |
| Heat Resistance | 120° F. | 132° F |

A similar technique can be used for grips for:

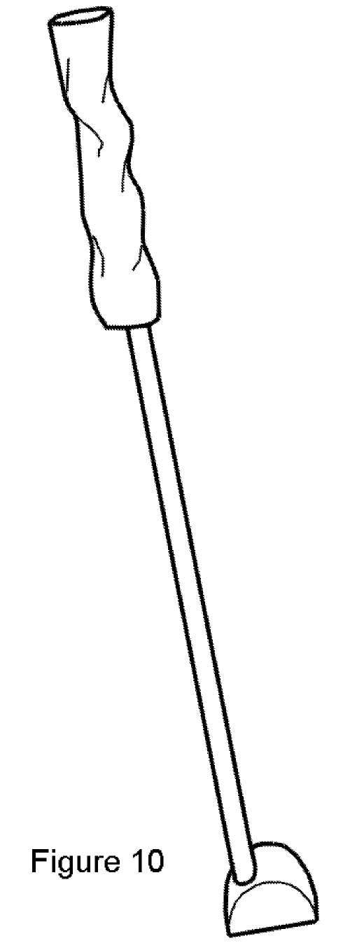

1. Golf Clubs—FIG. 10

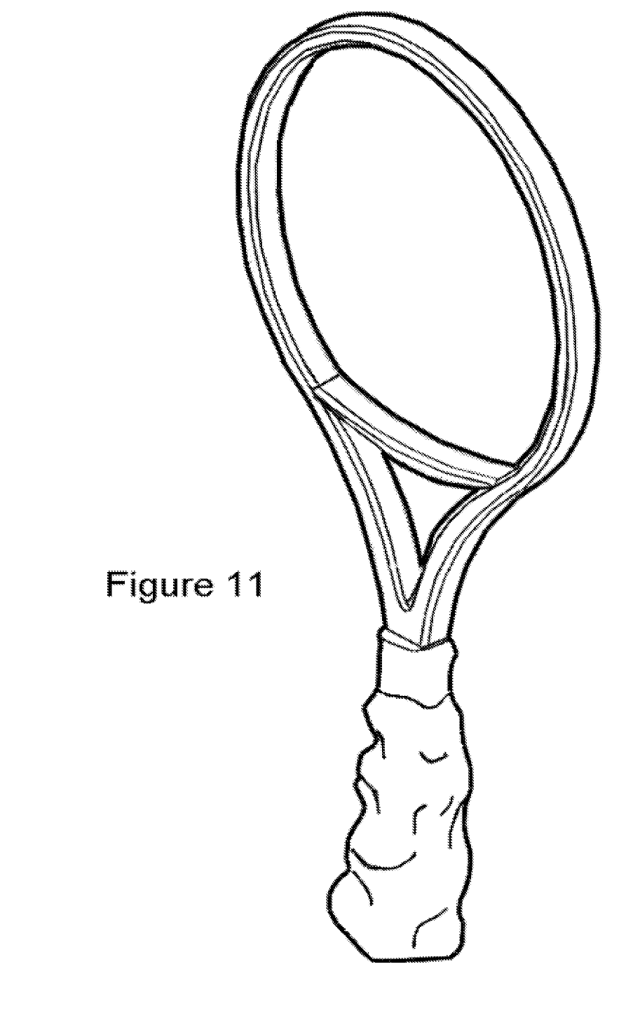

2. Tennis Racket—FIG. 11

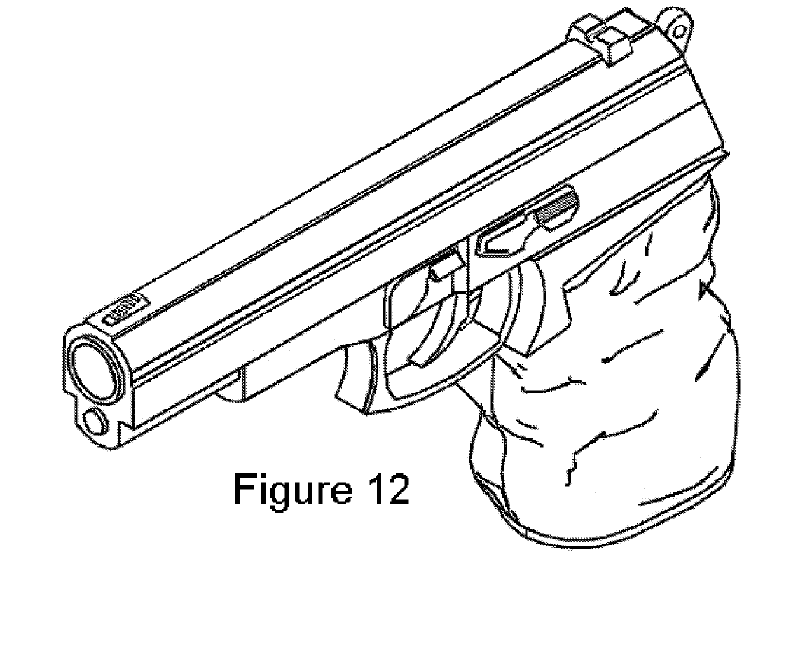

3. Hand Guns—FIG. 12

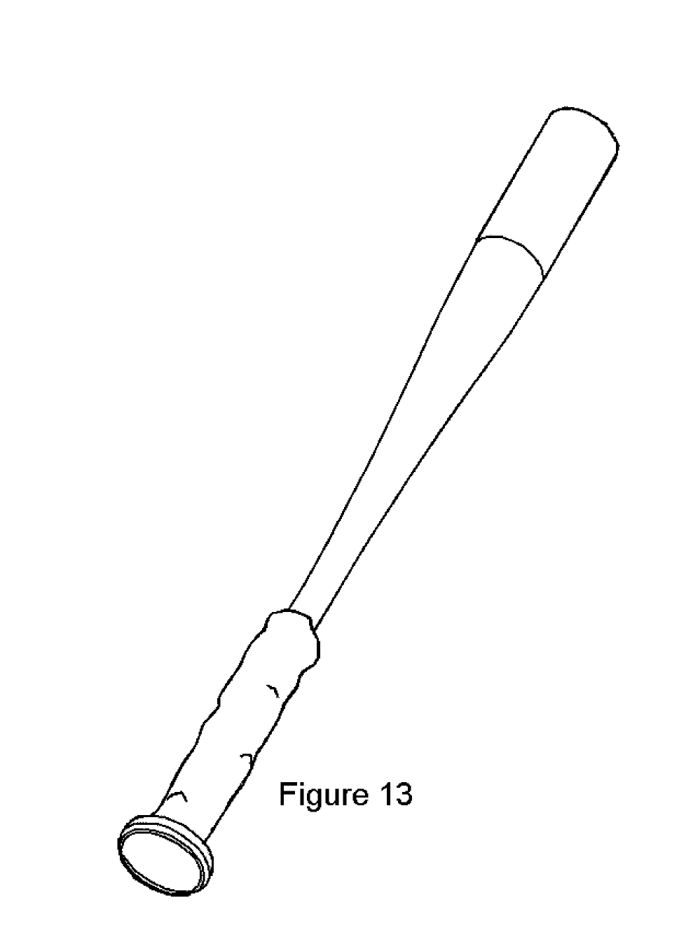

4. Baseball Bats—FIG. 13

5. Hockey Sticks

6. Power Tools

7. Hand Tools

8. Sports Implements

9. Medical Devices

10. Hand Held Instruments

Or any hand held device that is subject to impact or torque. As this invention minimizes the strength required to hold the device and still attain adequate control of the device.

What is claimed:

1. Custom Grips comprising thermoplastic material that is plastic at temperatures compatible with human touch.

2. Custom Grips comprising thermoplastic materials were the thermoplastic material is predominately a Polycaprolactone with or without fillers or additives.

3. Custom Grips comprising thermoplastic material where the thermoplastic material is predominately ethyl vinyl acetate with or without fillers or additives.

4. Custom Grips comprising thermoplastic material where the thermoplastic material is predominately a hot melt with or without fillers or additives.

5. Custom Grips comprising thermoplastic material of claim 1 with a plastic cover.

6. Custom Grips comprising thermoplastic material of claim 1 with a rubber cover.

7. Custom Grips comprising thermoplastic material of claim 1 with a plastic film cover.

8. Custom Grips comprising thermoplastic material of claim 1 with a fabric cover.

9. Custom Grips comprising thermoplastic material of claim 1 for writing instruments, sporting goods, fire arms, hand tools, power tools, and medical devices.
